(19) United States
(12) Patent Application Publication
(10) Pub. No.: US 2016/0094777 A1
(43) Pub. Date: Mar. 31, 2016

(54) IMAGE CAPTURING APPARATUS AND CONTROL METHOD THEREFOR, AND STORAGE MEDIUM

(71) Applicant: CANON KABUSHIKI KAISHA, Tokyo (JP)

(72) Inventor: Yumi Takao, Tokyo (JP)

(21) Appl. No.: 14/859,641

(22) Filed: Sep. 21, 2015

(30) Foreign Application Priority Data
Sep. 26, 2014 (JP) 2014-197509

(51) Int. Cl. H04N 5/232; H04N 9/04; G06T 5/30; H04N 5/378

(52) U.S. Cl. CPC H04N 5/23212; H04N 5/378; H04N 9/045; G06T 5/30; G06T 2207/10024

(57) ABSTRACT

An image capturing apparatus includes: an image sensor having a plurality of pixels arranged two-dimensionally; a readout unit that reads out, from the pixels of the image sensor, signals for focus detection by thinning out pixels at a cycle corresponding to a predetermined pixel interval or adding the thinned-out pixels; a focus detection unit that detects an in-focus position of an imaging lens based on the signals for focus detection read out by the readout unit; a determination unit that determines whether or not a focus detection result of the focus detection unit varies depending on a phase of the thinning out or adding carried out when reading out the signals for focus detection; and a correction unit that corrects the focus detection result of the focus detection unit based on a determination result of the determination unit.

### BACKGROUND OF THE INVENTION

1. Field of the Invention

The present invention relates to an image capturing apparatus that performs focus detection using an image signal obtained by an image sensor that photo-electrically converts a subject image formed by an imaging optical system.

2. Description of the Related Art

In digital cameras and video cameras, it is typical to employ a contrast detection-type autofocus (“AF” hereinafter) method that uses an output signal from an image sensor such as a CCD, a CMOS sensor, or the like to detect a signal based on focus evaluation values of a subject and bring the subject into focus. With this method, the focus evaluation value of the subject is sequentially detected (an AF scanning operation) while moving a focus lens in an optical axis direction across a predetermined movement range, and a focus lens position where the focus evaluation value is highest is detected as an in-focus position.

Meanwhile, an image capturing apparatus that, to prevent erroneous detection and increase the accuracy of the focus detection, determines whether or not in-focus position detection is reliable from a shape of the focus evaluation values is known. Furthermore, there are cases where, in order to accelerate focus detection, an output signal is used after being thinned out only when carrying out focus detection.

Japanese Patent No. 4235422 enables highly-accurate focus detection by finding numerical values of a shape of the focus evaluation values based on a lens position where a maximum focus evaluation value has been obtained, nearby lens positions, and the focus evaluation values and determining whether or not the shape of the focus evaluation values has the correct peak shape near the in-focus position.

However, according to the conventional technique disclosed in the stated Japanese Patent No. 4235422, it is possible that sufficiently accurate focus detection cannot be achieved. Although an in-focus position typically corresponds to the lens position where the focus evaluation value is highest, the in-focus position does not necessarily correspond to the lens position where the focus evaluation value is highest in the case where the output signal is thinned out in order to accelerate AF operations.

### SUMMARY OF THE INVENTION

Having been achieved in light of the aforementioned problem, the present invention provides an image capturing apparatus that enables highly-accurate focus detection even in the case where an output signal is thinned out.

According to the first aspect of the present invention, there is provided an image capturing apparatus comprising: an image sensor having a plurality of pixels arranged two-dimensionally; a readout unit that reads out, from the pixels of the image sensor, signals for focus detection by thinning out pixels at a cycle corresponding to a predetermined pixel interval or adding the pixels; a focus detection unit that detects an in-focus position of an imaging lens based on the signals for focus detection read out by the readout unit; a determination unit that determines whether or not a focus detection result of the focus detection unit varies depending on a phase of the thinning out or adding carried out when reading out the signals for focus detection; and a correction unit that corrects the focus detection result of the focus detection unit based on a determination result of the determination unit.

According to the second aspect of the present invention, there is provided a method of controlling an image capturing apparatus including an image sensor having a plurality of pixels arranged two-dimensionally, the method comprising: reading out, from the pixels of the image sensor, signals for focus detection by thinning out pixels at a cycle corresponding to a predetermined pixel interval or adding the pixels; detecting an in-focus position of an imaging lens based on the signals for focus detection read out in the reading out; determining whether or not a focus detection result in the detecting varies depending on a phase of the thinning out or adding carried out when reading out the signals for focus detection; and correcting the focus detection result in the detecting based on a determination result in the determining.

Further features of the present invention will become apparent from the following description of exemplary embodiments (with reference to the attached drawings).

### BRIEF DESCRIPTION OF THE DRAWINGS

FIG. 1 is a block diagram illustrating the overall configuration of an image capturing apparatus having a focal point adjustment unit according to an embodiment of the present invention.

FIG. 2 is a flowchart illustrating an AF operation procedure of the focal point adjustment unit.

FIG. 3 is a diagram illustrating the setting of a focus detection region.

FIGS. 4A, 4B, and 4C are diagrams illustrating an arrangement of focus detection pixels.

FIG. 5 is a diagram illustrating focus evaluation values.

FIGS. 6A and 6B are diagrams illustrating a relationship between focus detection pixel phases and focus evaluation values.

FIG. 7 is a diagram illustrating a method for determining a reliability of a focus evaluation value.

FIG. 8 is a diagram illustrating a phase countermeasure method for a focus evaluation value.

### DESCRIPTION OF THE EMBODIMENTS

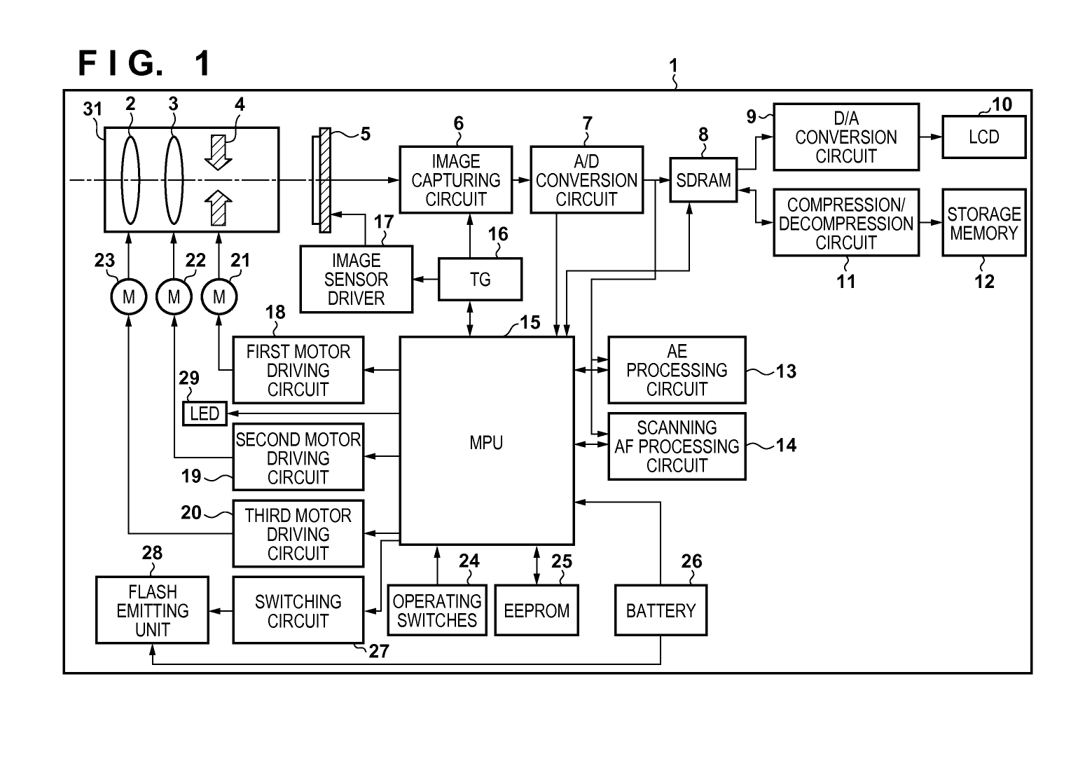

Hereinafter, an embodiment of the present invention will be described in detail with reference to the appended drawings. FIG. 1 is a block diagram illustrating the overall configuration of an image capturing apparatus having a focal point adjustment unit according to an embodiment of the present invention. The image capturing apparatus includes a digital still camera and a digital video camera, for example, but is not limited thereto. The present invention can be applied in any device as long as the device obtains an electrical image by photo-electrically converting an incident optical image using a two-dimensionally-arranged solid-state sensor such as an area sensor.

In FIG. 1, 1 indicates the image capturing apparatus. 2 indicates a zoom lens group and 3 indicates a focus lens group, which constitute an imaging optical system. 4 indicates a diaphragm serving as a light amount adjusting unit that controls a light flux amount that traverses the imaging optical system, and is an exposure unit. 31 indicates an imaging lens constituted by the zoom lens group 2, the focus lens group 3, the diaphragm 4, and so on.

5 indicates an image sensor, such as a CCD or a CMOS sensor, on which the subject image that has traversed the imaging optical system is formed and in which a plurality of pixels that photo-electrically convert that image are arranged two-dimensionally. 6 indicates an image capturing circuit that receives an electrical signal resulting from the photo-electric conversion performed by the image sensor 5 and generates a predetermined image signal by executing various types of image processes. 7 indicates an A/D conversion circuit that converts the analog image signal generated by the image capturing circuit 6 into a digital image signal.

8 indicates a memory (SDRAM) such as a buffer memory that temporarily stores the digital image signal output from the A/D conversion circuit 7. The SDRAM 8 can record a sensor output signal from a partial region in an image capturing region of the image sensor 5. Focus detection can be carried out via an MPU by a scanning AF processing circuit 14, which will be mentioned later, based on the output signal recorded in the SDRAM 8. 9 indicates a D/A conversion circuit that reads out the image signal stored in the SDRAM 8 and converts that signal into an analog signal, and that also converts the signal into an image signal in a format suitable for playback and output.

10 indicates an image display unit (“LCD” hereinafter) such as a liquid crystal display device (LCD) that displays the image signal. 12 indicates a storage memory that is constituted by a semiconductor memory or the like and that stores image data. 11 indicates a compression/decompression circuit constituted by a compression circuit that carries out a compression process and a decompression circuit that carries out a decoding process, a decompression process, and the like. The compression/decompression circuit 11 reads out the image signal temporarily stored in the SDRAM 8 and carries out a compression process, an encoding process, and so on, on image data in order to put the data into a format suited to storage in the storage memory 12. The compression/decompression circuit 11 also puts the image data stored in the storage memory 12 into a format optimized for playback, display, and the like.

13 indicates an AE processing circuit that carries out automatic exposure (AE) processing using the output from the A/D conversion circuit 7. 14 indicates the scanning AF processing circuit, which carries out autofocus (AF) processing using the output from the A/D conversion circuit 7.

15 indicates an MPU that includes a memory used for computations and that controls the image capturing apparatus. 16 indicates a timing generator (“TG” hereinafter) that generates a predetermined timing signal. 17 indicates an image sensor driver. 21 indicates a diaphragm driving motor that drives the diaphragm 4. 18 indicates a first motor driving circuit that drives and controls the diaphragm driving motor 21. 22 indicates a focus driving motor that drives the focus lens group 3. 19 indicates a second motor driving circuit that drives and controls the focus driving motor 22. 23 indicates a zoom driving motor that drives the zoom lens group 2. 20 indicates a third motor driving circuit that drives and controls the zoom driving motor 23.

Furthermore, 24 indicates operating switches constituted by various types of switch groups. 25 indicates an EEPROM, which is a read-only memory that can be electrically rewritten, and which stores, in advance, programs for carrying out various types of control, data used to perform various types of operations, and so on. 26 indicates a battery, 28 indicates a flash emitting unit, 27 indicates a switching circuit that controls the emission of flash light by the flash emitting unit 28, and 29 indicates a display element, such as an LED, for indicating whether or not AF operations have been successful.

Note that the storage memory 12, which is a storage medium for image data and the like, is a solid-state semiconductor memory such as a flash memory or the like, and has a card form, a stick form, or the like. However, a variety of other forms including magnetic storage media such as hard disks, flexible disks, or the like can be applied in addition to semiconductor memories such as card-type flash memories that are configured to be removable from the apparatus.

Meanwhile, the operating switches 24 include a main power switch, a release switch, a playback switch, a zoom switch, an on/off switch for displaying an AF evaluation value signal in a monitor, and the like. The main power switch is a switch for starting the image capturing apparatus 1 and supplying power.

The release switch starts shooting operations (storage operations) and the like. The playback switch starts playback operations. The zoom switch carries out zoom operations by causing the zoom lens group 2 in the imaging optical system to move. The release switch is constituted by a two-stage switch, in which a first stroke (“SW1” hereinafter) generates an instruction signal that starts AE processing and AF processing carried out prior to the shooting operations and a second stroke (“SW2” hereinafter) generates an instruction signal that starts actual exposure operations.

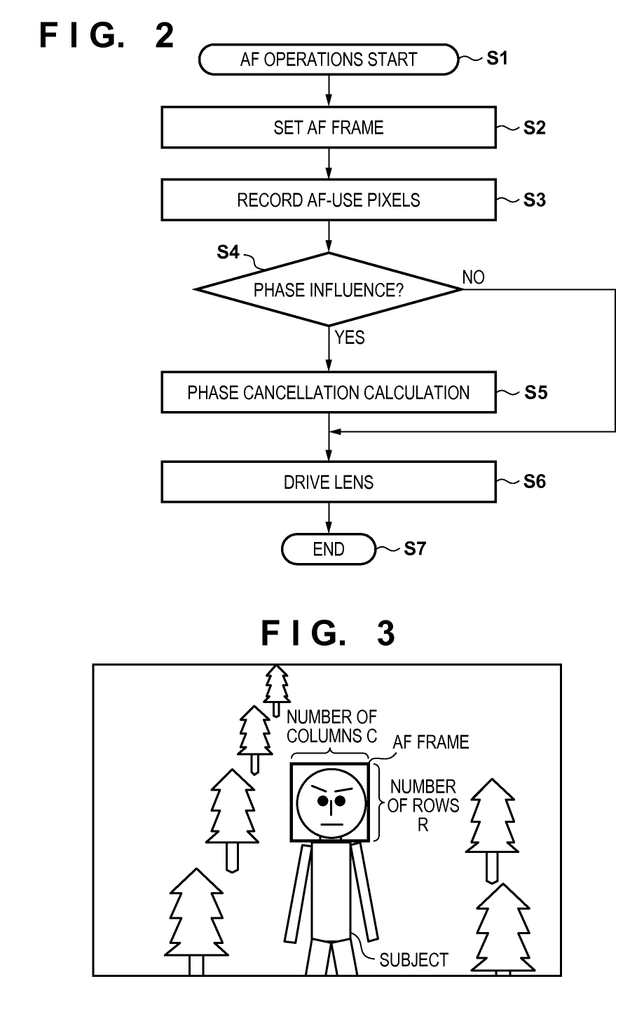

Next, focusing operations (AF operations) of the image capturing apparatus having the stated configuration will be described with reference to FIG. 2. FIG. 2 is a flowchart illustrating an AF operation procedure of the image capturing apparatus. A control program for these operations is executed by the MPU 15.

When the AF operations are started in step S1, the MPU 15 first sets an AF frame. In the processing of step S2, a position and size of a frame for carrying out AF is set with respect to an entire image region, as indicated in FIG. 3. The position and size of the AF frame may be determined as desired in accordance with a shooting mode. FIG. 3 is a diagram depicting an AF frame set to the face of a person in a face detection mode. The MPU 15 records the position and size of the AF frame at this time and executes the AF operations, which will be described below, using output signals obtained from the image sensor 5 within the AF frame.

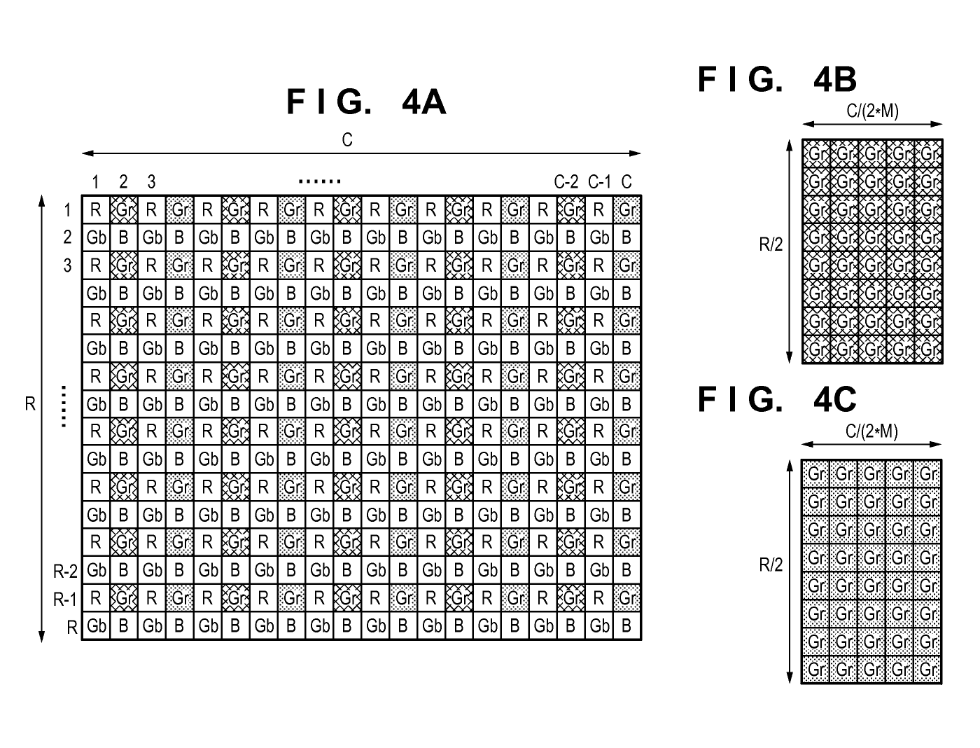

Next, in step S3, AF-use pixels are recorded from the output signals of the region set in step S2. The AF-use pixels will be described using FIGS. 4A to 4C. FIG. 4A is an example of an output signal array within the AF frame, and FIGS. 4B and 4C are examples in which the AF-use pixels at that time have been extracted.

The output signals obtained from the image sensor 5 are generally in the form of a Bayer array. A Bayer array has a structure in which color filters where (odd row, odd column)=R (red), (odd row, even column)=Gr (green), (even row, odd column)=Gb (green), and (even row, even column)=B (blue), for example, are arranged on the image sensor 5, as indicated in FIG. 4A. Here, carrying out focus evaluation value computations for AF on all of the output signals as indicated in FIG. 4A results in a high processing load, and thus it is often the case that the AF focus evaluation values are computed having extracted only the necessary information. This is called “thinning out” in the present embodiment. In the present embodiment, the pixels are thinned out at a cycle corresponding to a predetermined pixel interval, and the signals are then read out.

Here, FIG. 4B indicates the AF-use pixels in the case where only the Gr pixels of the output signals indicated in FIG. 4A have been thinned out to ½. When a thinning-out rate 1/M is set to ½, an extraction pitch becomes 2×M, and in the case where the output signals corresponding to the hatched areas in FIG. 4A are extracted, output signals extracted in the following order correspond to the content illustrated in FIG. 4B:
(1,2), (1,6), (1,10), . . . , (1,C-6), (1,C-2), (3,2), (3,6), (3,10), . . . , (3,C-6), (3,C-2), . . . , (R-3,2), (R-3,6), (R-3,10), . . . , (R-3,C-6), (R-3,C-2), (R-1,2), (R-1,6), (R-1,10), . . . , (R-1,C-6), (R-1,C-2)
   Likewise, in the case where output signals corresponding to the different-phase dotted areas in FIG. 4A are extracted from the output signals indicated in FIG. 4A, output signals extracted in the following order correspond to the content illustrated in FIG. 4C:
(1,4), (1,8), (1,12), . . . , (1,C-4), (1,C), (3,4), (3,8), (3,12), . . . , (3,C-4), (3,C), . . . , (R-3,4), (R-3,8), (R-3,12), . . . , (R-3,C-4), (R-3,C), (R-1,4), (R-1,8), (R-1,12), . . . , (R-1,C-4), (R-1,C)

In this manner, in step S3, by thinning out all of the output signals within the AF frame and recording the AF-use pixels (focus detection pixels), the amount of time required for the focus detection can be reduced. Meanwhile, as described above, thinning-out methods having different phases arise depending on the thinning-out method, and thus AF-use pixels such as those illustrated in FIGS. 4B and 4C can be created. Although a method in which the thinning-out process is carried out and the AF-use pixels are formed is described here, the thinning out may be carried out after finding an arithmetic mean, or the thinning out may be carried out after adding the colors of the output signals. Furthermore, although the color is described as only green, the method is not limited to green, and signals of pixels corresponding to other single-color color filters may be read out as signals for focus detection.

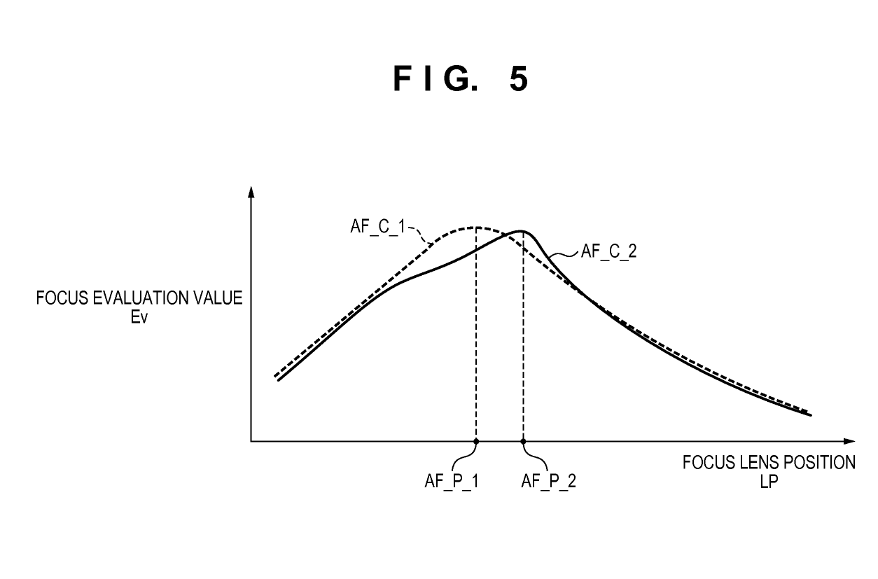

Next, in step S4, it is determined whether or not there is phase influence in the detected focus evaluation values. An example of a phase determination method will be described using FIG. 5.

First, in the example of operations indicated in step S4, focus evaluation values at each of focus lens group positions are stored in the MPU 15 by the scanning AF processing circuit 14 while moving the focus lens group 3 by predetermined amounts from a scanning start position to a scanning end position. FIG. 5 illustrates an example of a relationship between a focus lens position LP and a focus evaluation value Ev. FIG. 5 illustrates variations AF_C_1 and AF_C_2 in the focus evaluation value Ev when the focus lens is driven. AF_C_1 and AF_C_2 indicate variations in the focus evaluation value when the AF-use pixels having different phases thinned out in step S3 are used. Variation in the focus evaluation value in the case where the focus evaluation value is calculated using the AF-use pixels indicated in FIG. 4B is expressed by AF_C_1, whereas variation in the focus evaluation value in the case where the focus evaluation value is calculated using the AF-use pixels indicated in FIG. 4C is expressed by AF_C_2.

The focus evaluation value Ev is a value expressing a contrast value of a subject as a parameter, and is generally calculated as an absolute value of a derivative or the like. Accordingly, the focus evaluation value Ev is a parameter having a higher value as the state approaches an in-focus state, and in FIG. 5, focus lens positions AF_P_1 and AF_P_2 are closest to an in-focus position.

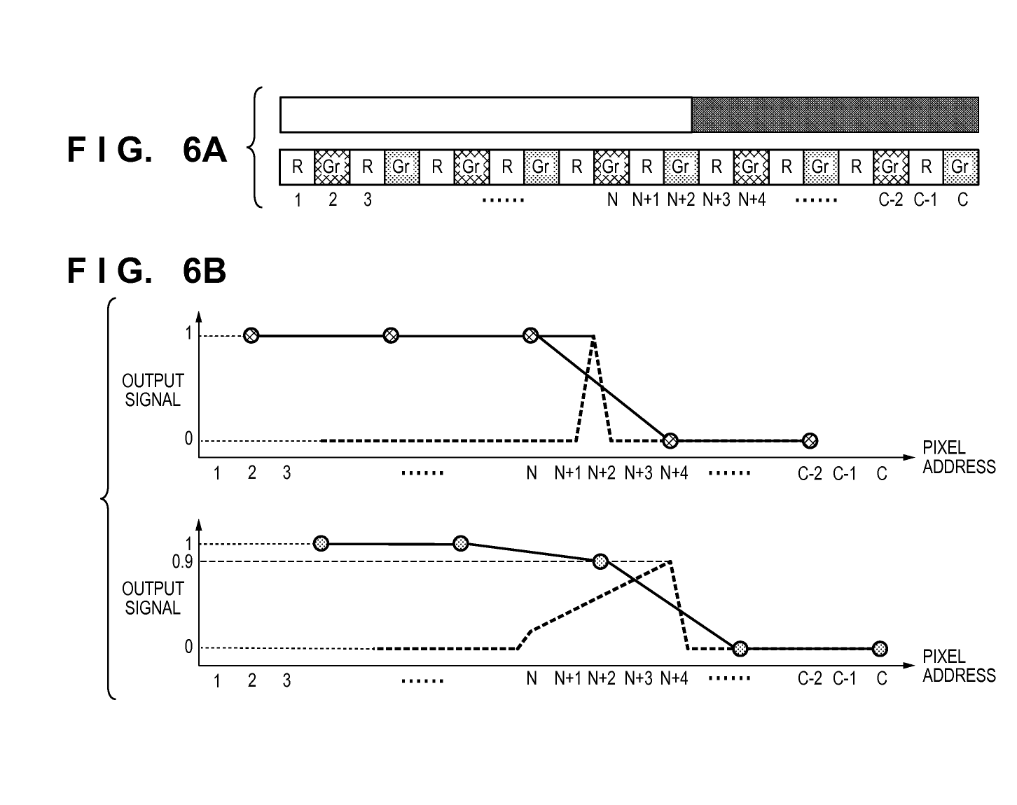

A reason for a difference arising in the detected in-focus positions AF_P_1 and AF_P_2 near the in-focus position between the thinning-out phases (AF-use pixels 1 and AF-use pixels 2) for the same subject will be described using FIGS. 6A and 6B.

FIG. 6A is a schematic diagram illustrating an edge subject in an upper area, and a correspondence relationship in the image sensor 5 that receives a subject signal from the edge at that time. When the output signal of a given row has a relationship with the subject as indicated in FIG. 6A, and a white-area output is taken as 1 and a black-area output is taken as 0, an AF-use pixel signal Gr-1 (a hatched area) corresponds to the solid line in the upper area of FIG. 6B. Meanwhile, an output signal of an AF-use pixel signal Gr-2 (a dotted area) corresponds to the solid line in the lower area of FIG. 6B. Respective derivatives (contrast values) at this time are indicated by dotted lines. The stated focus evaluation value is a parameter expressing a sharpness of the subject, and is expressed as an absolute maximum value of the derivative of the output signal, for example; thus the focus evaluation value of Gr-1 is 1 and the focus evaluation value of Gr-2 is 0.9.

In this manner, a determination result in which the focus evaluation value varies due to the phase of the thinning-out even in the same subject is expressed as the influence of phase in the present embodiment. This phenomenon is likely to occur in the case where a subject edge is incident in a vertical direction relative to a readout direction of the image sensor (a horizontal direction, in the present embodiment), and is more likely to occur when a digital filter used when calculating the focus evaluation value has a higher band. This is because it is more likely for differences to arise in the output signals from the image sensor. The influence of phase is also more likely to occur the higher the thinning-out rate M used when extracting the AF-use pixel signals is.

In this manner, it is determined that the influence of phase is present in step S4 in the case where there is a difference in the in-focus positions AF_P_1 and AF_P_2 detected near the in-focus position between the thinning-out phases (the AF-use pixels 1 and the AF-use pixels 2). Here, in the case where the in-focus positions AF_P_1 and AF_P_2 are found for the respective focus evaluation values AF_C_1 and AF_C_2 and a variation amount threshold SH1 is set, it is determined that the influence of phase is present when:

|AF_P_{—}1−AF_P_{—}2|≧SH1

In the case where it is determined that the influence of phase is present, the procedure advances to step S5, whereas when such is not the case, the procedure advances to step S6.

Although the method for determining the influence of phase is described here as a method that calculates respective focus evaluation values from the AF-use pixels having different phases, the method is not limited thereto, and can be changed as long as it can be determined whether or not there is phase influence. For example, although the two types of AF-use pixels described above arise because of the ½ thinning-out, n types of AF-use pixels can be generated when thinning out at 1/n, and thus the determination may be made upon variation in a focus evaluation value peak AF_P_n being no greater than a threshold SH2. Meanwhile, even in the case where thinning-out is not carried out, AF-use pixel signals having different phases can be generated within the same color for Gr and Gb, as indicated in FIG. 4A; as such, the same phase determination as described above can be carried out.

Meanwhile, as described above, the influence of phase is likely to occur in the case where a subject edge enters in the vertical direction (is orthogonal to) the arrangement of the pixels in the image sensor. Accordingly, the direction of the subject edge may be detected and the influence of phase may be determined to be present in the case where the edge direction is nearly perpendicular to the readout direction of the image sensor. Likewise, the influence of phase is likely to occur due to the frequency band of the digital filter, such as in the case where the focus evaluation value is detected using a high-frequency filter, in which case the influence of phase may be determined to be present.

Next, in step S5, a phase cancellation calculation is carried out, and an in-focus position AF_P is calculated. For example, in the case where the focus evaluation values AF_C_1 and AF_C_2 are obtained and the respective focal positions AF_P_1 and AF_P_2 have been detected in step S4, the in-focus position is corrected as the average thereof:

AF_P=(AF_P_{—}1+AF_P_{—}2)/2

In the case where AF_P_n is detected for a plurality of AF-use pixels as described above, an average thereof may be used.

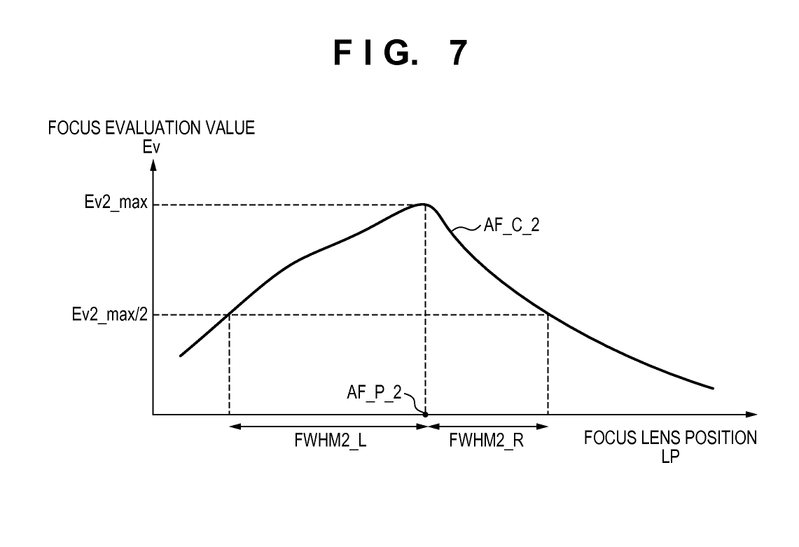

Another phase cancellation method will now be described. Generally, in the case where the influence of phase is present, it is likely that the shape of the focus evaluation value AF_C will be irregular near the in-focus position. For example, as illustrated in FIG. 5, in the case where the focus evaluation values AF_C_1 and AF_C_2 have been obtained, it is more likely that AF_C_2, which does not have a gentle peak shape near the in-focus position, is being influenced by phase, and AF_C_2 is therefore thought to have a low reliability. An example of a method that can be considered as a method for determining the reliability of a peak shape will be described using FIG. 7.

First, a half-width of a maximum value EV2_max of AF_C_2 is found. Half-widths FWHM2_L and FWHM_R are difference values between the focus lens position LP for EV2 max/2 and AF_P_2. If FWHM2_L and FWHM2_R indicate the same amount at this time, the peak shape of the AF_C_2 is thought to have a high reliability, and thus taking SH2 as the variation amount threshold, the value is determined to be reliable when:

|FWHM2_{—}L−FWHM2_{—}R|≦SH2

Here, a phase cancellation effect can be attempted by employing the focus evaluation value AF_C determined to be reliable and taking AF_P at that time as the in-focus position. In FIG. 5, AF_C_1 is employed, and the focus lens position AF_P_1 at which the focus evaluation value Ev is maximum at that time becomes the focus detection result.

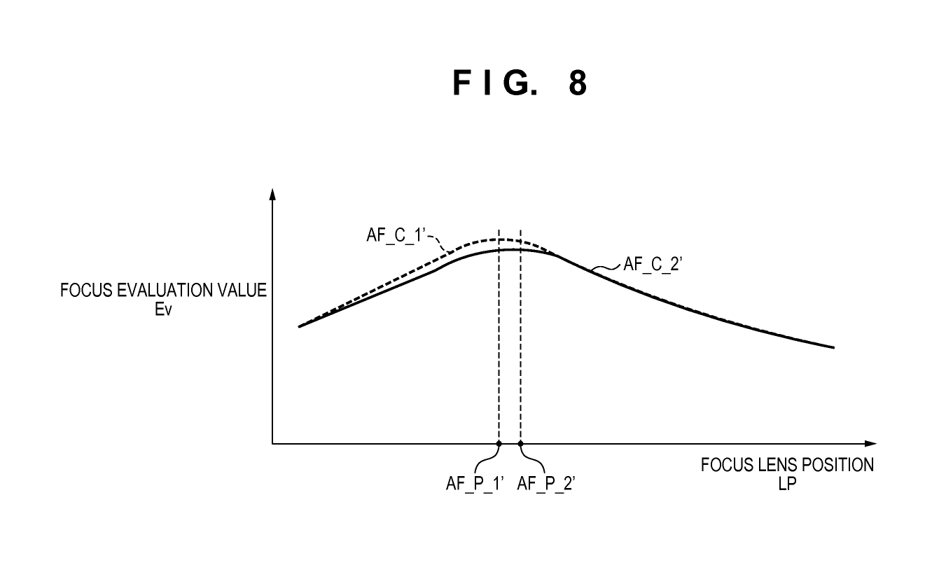

Meanwhile, the phase cancellation operations may be carried out as described below. An example of phase cancellation will be described using FIG. 8. As described earlier, it is likely that the influence of phase will occur when a subject edge is incident in the vertical direction relative to the image signal readout direction. In other words, the operations are more susceptible to the influence of phase when the subject contains many high-frequency components, and thus in an example of step S5, the band of a digital filter used in the focus detection is set to a low-frequency band. This variation is illustrated in FIG. 8.

In the case where the focus evaluation value has been obtained at a digital filter band D1 in FIG. 5, FIG. 8 illustrates an example of focus evaluation value variation in the case where a focus evaluation value has been obtained at D2, which is a lower band than D1. Generally speaking, when the digital filter band is set to a low band, the focus evaluation value shape AF_C has a gentle variation (AF_C_1′ and AF_C_2′), and the focal positions at that time (AF_P_1′ and AF_P_2′) have little phase influence and thus have a small difference. In this manner, the influence of phase can be reduced by setting the digital filter band to a low frequency, and thus in the case where the influence of phase has been determined to be present in step S4, the focus detection position AF P that uses a low-frequency band-pass filter may be employed. At this time, an average of the different-phase focal positions (AF_P_1′ and AF_P_2′) may furthermore be used.

Next, in step S6, the focus lens group 3 is driven to the position of AF_P found in step S5, and the series of operations ends.

As described thus far, according to the present embodiment, by detecting the focal position from the phase occurring when thinning out the AF-use pixels and the respective focus evaluation values, an image capturing apparatus that enables highly-accurate focus detection can be provided.

Although the aforementioned embodiment describes variation in a focus state of a subject as being realized through focus lens movement, the method for realizing variation in the focus state is not limited thereto. For example, the variation may be realized by moving the image sensor rather than the focus lens. In addition, the variation in the focus state may be realized through a reconstruction process in an image capturing apparatus capable of obtaining light ray incidence angle information (light field information).

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-197509, filed Sep. 26, 2014, which is hereby incorporated by reference herein in its entirety.

What is claimed is:

1. An image capturing apparatus comprising:
an image sensor having a plurality of pixels arranged two-dimensionally;
a readout unit that reads out, from the pixels of the image sensor, signals for focus detection by thinning out pixels at a cycle corresponding to a predetermined pixel interval or adding the pixels;
a focus detection unit that detects an in-focus position of an imaging lens based on the signals for focus detection read out by the readout unit;
a determination unit that determines whether or not a focus detection result of the focus detection unit varies depending on a phase of the thinning out or adding carried out when reading out the signals for focus detection; and
a correction unit that corrects the focus detection result of the focus detection unit based on a determination result of the determination unit.

2. The image capturing apparatus according to claim 1,
wherein a color filter is arranged on each of the plurality of pixels, and the readout unit reads out signals of pixels corresponding to a single color of the color filters as the signals for focus detection.

3. The image capturing apparatus according to claim 2,
wherein the readout unit further thins out the signals of pixels corresponding to the single color in the color filter at a predetermined cycle or adds the thinned-out pixels and reads out the resulting signals as the signals for focus detection.

4. The image capturing apparatus according to claim 1,
wherein based on a difference in detection results of the focus detection unit based on signals for focus detection in which a phase of the thinning out or the adding is different, the determination unit determines whether or not the focus detection result of the focus detection unit varies depending on the phase of the thinning out or the adding carried out when reading out the signals for focus detection.

5. The image capturing apparatus according to claim 1,
wherein the determination unit determines whether or not the focus detection result of the focus detection unit varies depending on a phase of the thinning out or adding carried out when reading out the signals for focus detection based on a direction of an edge of a subject relative to the image sensor.

6. The image capturing apparatus according to claim 5,
wherein the determination unit determines that the focus detection result of the focus detection unit varies in the case where the direction of the edge of the subject is a direction orthogonal to a direction in which the signals of the pixels are read out.

7. The image capturing apparatus according to claim 1,
wherein the determination unit determines whether or not the focus detection result of the focus detection unit varies depending on a phase of the thinning out or adding carried out when reading out the signals for focus detection based on a band of a filter applied to the signals for focus detection.

8. The image capturing apparatus according to claim 7,
wherein the correction unit changes the band of the filter to a low-frequency band in the case where it has been determined that the focus detection result of the focus detection unit varies depending on a phase of the thinning out or adding carried out when reading out the signals for focus detection.

9. A method of controlling an image capturing apparatus including an image sensor having a plurality of pixels arranged two-dimensionally, the method comprising:
reading out, from the pixels of the image sensor, signals for focus detection by thinning out pixels at a cycle corresponding to a predetermined pixel interval or adding the pixels;
detecting an in-focus position of an imaging lens based on the signals for focus detection read out in the reading out;
determining whether or not a focus detection result in the detecting varies depending on a phase of the thinning out or adding carried out when reading out the signals for focus detection; and
correcting the focus detection result in the detecting based on a determination result in the determining.

10. A non-transitory computer readable storage medium storing a computer-executable program for causing a computer to execute a method of controlling an image capturing apparatus including an image sensor having a plurality of pixels arranged two-dimensionally, the method comprising:
reading out, from the pixels of the image sensor, signals for focus detection by thinning out pixels at a cycle corresponding to a predetermined pixel interval or adding the pixels;
detecting an in-focus position of an imaging lens based on the signals for focus detection read out in the reading out;
determining whether or not a focus detection result in the detecting varies depending on a phase of the thinning out or adding carried out when reading out the signals for focus detection; and
correcting the focus detection result in the detecting based on a determination result of the determining.
